(19) United States
(12) Patent Application Publication
(10) Pub. No.: US 2002/0086733 A1
(43) Pub. Date: Jul. 4, 2002

(54) System and method for simultaneous participation in an online forum

(76) Inventor: Andy Wang, Diamond Bar, CA (US)

Correspondence Address: Todd W. Wight, Morrison & Foerster LLP, 555 West Fifth Street, Los Angeles, CA, 90013-1024, US

(21) Appl. No.: 10/002,976

(22) Filed: Nov. 14, 2001

Related U.S. Application Data
(63) Continuation-in-part of application No. 09/716,853, filed on Nov. 14, 2000.

(51) Int. Cl. A63F 13/00

(52) U.S. Cl. 463/42

(57) ABSTRACT

A system and method for simultaneous participation of remote users in an organized online forum. The forum can take many forms and shapes, such as a baseball game, where each player character on the baseball field is controlled by an individual participant, regardless of physical location. A user can choose a character having various characteristics, personalize the chosen character, and train the character to increase the character's ability. The user can organize or join a team for league play or can participate with others in a less formal setting. Both the characters and the playing forums are portrayed by enhanced three-dimensional graphics to add a life-like feel to the game.

### CROSS-REFERENCE TO RELATED APPLICATIONS

This application is a continuation-in-part of application Ser. No. 09/716,853, filed Nov. 14, 2000, which is incorporated fully herein by reference.

### FIELD OF THE INVENTION

This invention relates generally to a system and method for interactive participation over the Internet and more particularly to sports games and other activities where several remote users can simultaneously participate and interact with one another in an organized online forum.

### BACKGROUND OF THE INVENTION

The Internet has expanded nearly every aspect of our lives, providing easy access to a wide range of information that previously was not readily accessible. In addition, communication possibilities have been vastly increased via the Internet. Thus, great potential exists with regard to simultaneous participation in an organized online forum. One such organized forum would include a gaming forum, where remote users could gather to simultaneously play games. However, the prior art games currently offered over the Internet lack the realism and sophistication of console and handheld games.

The console games on platforms such as Microsoft X-box, Sega, Nintendo and Sony offer increasingly realistic graphics and highly developed situations along with a number of optional features. The handheld games, including the Nintendo Game Boy, also offer better graphics and more options than in the very recent past. Console and handheld games, however, generally allow only a few players of limited character development to compete in a single match or adventure. In addition, with regard to sports games, usually only one or two players can participate on the same team during a contest. Further, the characters in the games are not personalized and are limited in terms of growth regarding user development.

With the advent of the Internet, it is now possible for multiple players to participate in “massively multi-player” online games. These games, however, generally consist of role-playing adventure games and lack unique character development. What is missing in these massively multi-player games is a sports game where users can simultaneously participate with and against other users by logging onto a Web site at a particular time. However, to date there does not exist a forum or game where individuals can so participate. In particular, there does not exist a forum or game where remote users can participate as teammates, where each position on a sports team is represented by a different character and each character is controlled by a different user, and where each character controlled by the user can be personalized and independently developed by the user.

In addition, there should be a way for remote users to participate in organized forums outside of games, where the creation of characters controlled by the user would be useful in furthering entertainment or practical goals in a realistic setting. Examples would include online shopping, online dating services and online educational courses.

From the discussion above, it should be apparent that there is a need for a system and method for simultaneous participation in an organized forum, such as a game, where multiple users controlling multiple characters have the capability of developing unique characteristics for their characters and can participate simultaneously with and against each other in a realistic setting.

### BRIEF SUMMARY OF THE INVENTION

The invention enables the simultaneous participation of remote users in an organized online forum. The forum can be based on various themes, such as a baseball game where each player character on the baseball field is controlled by an individual participant, regardless of physical location. A forum is organized through a combination of software, which is installed on a user's computer, a series of servers, and an Internet Web site or sites. A user that has installed the software and logged onto a Web site, can choose a character having various characteristics, personalize the chosen character, and train the character to increase the character's ability. The user can organize or join a team for league play or can participate with others in a less formal setting. Both the characters and the playing forums are portrayed by enhanced three-dimensional graphics to add a life-like feel to the game.

What is claimed is a method for simultaneous participation of remote users on-line, wherein said users are provided software for installation on a computer that communicates with a network domain having a plurality of servers and a Web site, comprising the acts of providing a forum, wherein the forum is based on a theme; enabling said users to each create at least one unique character for participation in the forum; and enabling real-time interaction between said users participating in the forum with their respective characters, wherein the interaction comprises selective communication between said users.

### BRIEF DESCRIPTION OF THE DRAWINGS

Not Applicable

### DETAILED DESCRIPTION OF THE INVENTION

The following detailed description illustrates the invention by way of example, not by way of limitation, the principles of the invention. This description will clearly enable one skilled in the art to make and use the invention, and describes several embodiments, adaptations, variations, alternatives and uses of the invention, including what we presently believe is the best mode of carrying out the invention.

The invention will be described by way of illustration with reference to a particular application of the present invention, namely a baseball game that is played over the Internet by remote users, where each user controls a distinct three-dimensional character. While the following detailed description will be primarily directed to a baseball game, one of skill in the art will appreciate that the invention herein can be used for a multitude of other applications, a few of which will be discussed in more detail below.

### Preferred Embodiment

As stated, a preferred embodiment of the present invention is directed to a realistic baseball game to be simultaneously played over the Internet by remote users. It should be appreciated that the aspects of the preferred embodiment of the game described herein are directly related to providing a game that simulates real-life situations. Thus, one can imagine other features in addition to, or in place of, those described herein which would add to the real-life feel of the game, and therefore be within the scope of the present invention.

In order to participate, a user first installs the necessary software on his computer (the software being obtainable via download from a Web site or on a CD, for example) and subsequently logs onto a designated Web site where the user inputs a user identification and password for registration into the system. Once registered, the user will have the option of choosing characteristics for the baseball player character that the user will control. Of course, while the preferred embodiment utilizes software in addition to a Web site, an alternate embodiment would consist of only a Web site.

Generally, the user will provide means of payment, such as a credit card, to complete the registration process. In one embodiment of the invention, the user will purchase the software for a certain price and pay a monthly fee to maintain access to the Web site and the forums provided thereon. It is also possible for a team of users to be assembled where a sponsor for the team would provide one or both fees for all members of the team. In such a case, for example, the sponsor could advertise on the logo of the team's uniform.

Each character established upon registration of a user possesses both optional and assigned characteristics. Optional characteristics include, for example, the character's appearance, playing position, uniform logo and uniform color. Assigned characteristics include, for example, a random DNA value for different physical attributes. Of course many other characteristics are possible and the examples given are interchangeable, meaning that it would be possible for the assigned characteristics to be optional and vice versa.

In the preferred embodiment of the present invention, the user chooses optional characteristics from nine distinct categories which allow the user to personalize his/her character. A first category is a character name for which the user can choose his own or a fictional name. This name will accompany the character and be displayed near the character (for example, in a box over the character's head). A second category is the player's sex, in which both female and male characters are possible. A third and fourth category are the player's face and body, in which a number of different types are possible. The structure of the face can be chosen based on, for example, a particular nationality, while the body structure can be one that is short and stocky, tall, muscular, etc. Along with the face and body types are a fifth and sixth category which enables the user to choose the character's skin tone and eye color. It should be noted that these chosen features can be changed at any time by the user to give his character a different look (although a fee may be required to do so).

In one unique aspect of the present invention, rather than choose face type, skin tone and eye color for the character, the user is enabled to upload pictures of himself to attach to the character. In the preferred embodiment, the user will be required to upload three different views, including a front view, a right profile and a left profile so that the character's three-dimensional image can be created. Computer software will then assimilate these different views into the user's character. Obviously, this aspect greatly enhances the personal aspect of the invention as users can enjoy participating in a game with their own likeness.

A seventh category allows the user to choose the position of the player, including catcher, pitcher, first base, second base, third base, shortstop, left field, right field and center field. The choice of position does not prohibit the character from playing a different position; however, the assigned characteristics will be specific to the position chosen. Thus, if the user chooses his character's position as left field and subsequently participates in a game as a catcher, the character will not be as adept at playing the catching position as would a character chosen with the position of catcher. Akin to the position is an eighth category in which the user can choose which hand the character throws with as well as which side of the plate is the natural hitting side for the character. As will be explained in detail below, the user will be able to train the character and could, for example, train the character to hit from both sides of the plate. Finally, in a ninth category, the user is able to choose the character's uniform number and logo. In an alternate embodiment, the user will be able to create a unique logo for the uniform. The logo could be created by using a number of software applications for upload onto the Web site. Certainly, other ways of logo creation are also possible in the spirit of the invention.

The assigned characteristics in the preferred embodiment of the present invention comprise a DNA value, which encompasses many different aspects of the character's constitution. Each character is assigned a total DNA value which is identical for all of the registered characters; however, the way in which this value is distributed has random and specific aspects. More particularly, different physical, emotional and mental aspects will be assigned a value based on the position chosen and/or randomness. There could be a DNA value assigned to characteristics such as what pitches the pitcher can initially throw effectively, whether the character has innate switch-hitting ability and the character's batting stance.

In the preferred embodiment of the present invention, the DNA value has seven specifically assigned categories, including five physical categories (speed, power, average, defense and arm strength) a category for mental make-up and a category for emotional make-up. If, for example, the determined DNA value is 100, the values assigned to each of the seven categories must add up to 100. As stated, the assignment of these values can be random or more calculated based on criteria such as position chosen. In addition the random values can have certain ranges to avoid the instance where an extremely low or high value is assigned to a particular characteristic. One of skill in the art can envision many variations to the DNA value aspect of the present invention where numerous categories are possible, as well as methods of assigning values and the foregoing should be taken as merely an example of the present invention.

Once the optional and assigned characteristics are inputted, the character is created and is ready to be controlled by the user in a training or game environment. The character can be trained numerous ways to increase the ability of the character in relation, for example, to hitting (power and average), fielding, throwing, accuracy and decision making. Of course, one can imagine other ways in which a character's ability can be improved as well. The training can take place in various settings, such as a batting cage, a field of play or a track (for example to increase speed of the player). By training the character, the user can increase the character's value with respect to the DNA assigned characteristics in each assigned area. Thus, for instance, if a character was initially assigned a value of 60 out of 100 in the area of throwing accuracy, then training the character by practicing hitting a target could incrementally increase the value. Similarly, by lack of training, the character could lose value for a particular DNA assigned characteristic. This could occur, for example, if the player did not participate in training or games for two weeks. Obviously the variables with regard to the valuation of characteristics as they relate to training are quite numerous and one can envision a multitude of ways to implement this inventive idea.

It should be noted that a user is able to create more than one character for use in the game and the other characters can be established with the same or different playing positions. However, in the preferred embodiment, only one character can be trained or used at a particular time and the training and use of that character increases only its value and not the value of any other characters, which the user may have established.

In the preferred embodiment, a registered user that has created a character is able to participate in a number of ways with his character. In one embodiment, the user can log onto a designated Web site and discover whether other users are also logged on for the purpose of starting a “pick-up” game (where the users would meet, for example, in a designated chat forum). If enough users are available, the game can be played at any time at a stadium or field of their choosing. In addition, one can envision a situation where players are needed and a message is posted, requesting the necessary player or players. In another embodiment of the present invention, a user that wishes to play in a more organized setting will be able to establish a registered team for league play, in which the user can assemble the team with other users or be assigned to a team randomly by the Web site. Alternatively, the user that establishes a registered team could recruit other players through the Web site.

A registered team will consist of at least nine players for each position, but can include other players, such as reserve players for the instance when a “starter” is not able to participate at a designated time. In addition, during the course of a game, substitutes such as pinch hitters or pinch runners could be employed. Further, in one embodiment of the invention, artificial intelligence is used in a league game setting so that if a user has to abandon the game, the artificial intelligence will simulate the departing player for the remainder of the game. Of course, in league play a minimum number of artificial intelligence characters would be allowed as well as a maximum number of innings for play by the artificial intelligence characters.

In a preferred embodiment of the invention, the stadiums and fields on which the games are played are portrayed in three-dimensional graphics and resemble actual professional stadiums. This can be accomplished, for example, by taking digital photos of the stadiums and translating them into graphics. Of course, there are many different professional stadiums possible, such as Major League Baseball stadiums, Minor League Baseball stadiums and stadiums from professional baseball associations in countries other than the United States. Also, the stadiums can be progressively designed, where the stadiums do not resemble actual stadiums and instead provide a futuristic feel. In another aspect of the invention, advertisements from sponsors could be incorporated into the stadiums. For example, an advertisement could appear on a stadium facade or on an outfield wall. In the preferred embodiment, users are able to choose the stadium where the game is played from a menu.

As mentioned, users can participate in league play that is organized and scheduled by the Web site. Many different embodiments are imaginable for setting up and conducting leagues for competition, but in the preferred embodiment, the leagues are established based on registered teams in similar time zones. A user that has assembled a team may register that team on the Web site by inputting a chosen team name along with the user identification of each of the members of the team. The Web site produces league schedules based on the number of teams in a particular time zone and distributes the schedule to the respective registered teams. The leagues can be broken up into divisions and conferences, depending on how many teams are in the league. Alternatively, leagues could be established by the users, in which the Web site merely facilitated the forming thereof (for instance by providing alternatives), where parameters and incentives could be set by the users.

In the preferred embodiment, the league games are played in a league season, where the number of games to be played is set at the beginning of the season with the goal of crowning a league champion at the end of the season. Following the season, a series of elimination tournaments can be conducted until a league champion is crowned. Following the league tournaments, championship tournaments can also be conducted between the league champions to determine a world champion for a particular season. Select league games and tournament games could be broadcast on-line to an audience comprising users not participating in the games and non-users interested in viewing the competition. Games of great magnitude and interest, such as a championship game, could also be broadcast on television locally, regionally or nationally.

In one embodiment of the invention, leagues can be organized based on skill level, where more experienced teams would be placed in a higher level and all teams would have the ability to work their way up through a series of levels. For example, all registered teams could initially begin at an “Amateur Level” and work up to “Semi-Pro” and from there “A” then “AA” then “AAA” and finally “Pro.” The move up in levels could be dictated by a point total, where points would be awarded for wins and other categories such as fewest errors in a season, most hits in a season, etc. These categories could also apply to the individual character in increasing the value of the character's abilities. Additionally, users on winning teams and champions of leagues could receive virtual money to increase their respective character's abilities or to purchase products made available by the Web site. This virtual money could also be presented for other accomplishments, such as the player of the week for each league or all users.

Referring back to the training aspect of the invention, in addition to the individual training of the characters, registered teams would be able to conduct practices with all or a portion of the team (users). These practices could take on various forms, such as on a practice field, where batting practice and fielding practice could take place. The practices could be scheduled, for example, by a team leader who would organize the time for the practice and designate a “place” by arranging for the team to log onto a particular portion of the Web site.

In reference to the actual playing of the game with regard to users control of their characters, in one embodiment of the invention, the longer the game goes on, the harder the characters would be to control. This aspect also adds realism to the game to simulate the character's fitness or lack thereof.

During simultaneous participation in either a competitive game or training environment, the users will be able to communicate with each other through chat or voice over IP (VOIP) functions. In the preferred embodiment, users will communicate utilizing VOIP, where only the user's teammates will be able to hear him. Similarly, if the user wishes to type his messages, rather than speak them, he can do so with only his teammates being able to see the message. This aspect adds an additional element of realism to the game and increases the interaction between teammates, which adds to the enjoyment of the game. In an alternate embodiment, the user will be able to direct his messages to a particular teammate or to a member or members of the other team by pressing a certain designated key on the keyboard or by indicating a character to which the message should be relayed in some other manner, such as through the use of a mouse.

Another aspect of the game in the preferred embodiment is that the users see the field from a viewpoint that is unique to their character. In other words, if the character is playing the left field position, the user will see the field from the left-fielder's perspective. At each viewpoint, various views and angles can be utilized by the user according to his preference. The views from which the user can choose include places around the viewpoint from which the field is seen. For example, the view can be established from the front of the character (as in real life), or behind the character's head (for a greater perspective of the field). The angles are taken from the particular view and in the preferred embodiment are based on the action taking place on the field. The user can always change the views or angles at his discretion.

The architecture for the present invention comprises a domain having at least a plurality of servers and a Web site. In the preferred embodiment, the Web site administers the traffic for the game, utilizing numerous servers that are distributed world-wide to enable smooth movement of characters and transmission of communication in real-time. The servers can be regionally or locally based depending on where large numbers of users are located. The Web site would also be linked to a database that would record and assemble the statistics for all of the characters registered. In addition, the Web site could offer many other features such as a daily sports page, with updates and standings for different leagues as well as stories on individual users (i.e., player of the week). In addition, daily, weekly and/or monthly chat sessions could be hosted by the web site with famous professional or retired athletes. These chat sessions could serve a dual purpose of entertainment as well as information regarding the fundamentals of baseball.

### Alternate Embodiments

While the preferred embodiment has been described above with regard to a baseball game, certainly one of skill in the art can extrapolate the ideas presented herein to other sports games such as soccer, football, basketball, hockey, etc. However, the scope of the present invention extends far beyond that of merely sports games. The inventiveness of providing an interactive platform that allows simultaneous participation of remote users is truly wide-ranging and useful.

An example of a non-sports game use for the present invention is for educational purposes. Thus, one can envision a classroom setting where users log onto the Web site and create a character based on how they wish to appear to others. As explained above, the user can upload digital pictures of himself/herself to be assimilated into the character. In the classroom environment, the professor would present material to the class from a computer and the students (users) would participate from their computers. A classroom setting would then be established. Both the professor and students would be able to talk using VOIP in real-time to either the rest of the class or on an individual basis. Likewise, students could talk to each other without interrupting the class, or set up a meeting after the class is over. While classes are currently offered over the internet, the level of interactivity is severely limited compared to the present invention. The classroom aspect of the present invention is advantageous in a number of ways, including being able to take courses of one's choosing regardless of physical location, eliminating the need to travel and eliminating the problem of missing vital notes (as the professor's lecture could be automatically translated into a Word document). Of course there are further aspects to an interactive classroom that would be apparent to one of skill in the art that would be within the scope of the present invention.

Another example of an inventive use for the present invention is in the shopping arena. The user could create a character based on his exact likeness, including body frame and face by uploading a plurality of pictures to be assimilated by the computer into the user's character. One aspect would be to shop for clothes or other articles requiring a fitting, in which the user could try on virtual clothes without leaving his home. Another aspect would be car shopping, in which a dealer could upload pictures of a showroom and cars, and the user could look at the cars and interact with the salesman utilizing his character. VOIP would be used to interact with the salesman in real-time. This would offer those who may be intimidated by the car buying experience a life-like alternative.

It should be appreciated that countless other embodiments are possible that would be within the scope of the present invention. Further examples include aspects of the professional world, such as attorneys, accountants and others, who could upload pictures of their offices for interaction with users regardless of the users' location. Thus, one could imagine a situation where an accountant in California could conduct business with a client in Alaska. Other possibilities include a gathering of friends, a science forum involving experts around the world, a religious leader speaking to a congregation of remote worshipers, and a dating forum where people could get together in an informal setting. Of course, there are many other uses not mentioned herein that would be within the scope of the invention as described.

The present invention has been described above in terms of a presently preferred embodiment and a select few alternate embodiments so that an understanding of the present invention can be conveyed. There are, however, many aspects not specifically described herein but with which the present invention is applicable. The present invention should therefore not be seen as limited to the particular embodiments described herein, but rather, it should be understood that the present invention has wide applicability with respect to simultaneous participation over the Internet. All modifications, variations, or equivalent arrangements and implementations that are within the scope of the attached claims should therefore be considered within the scope of the invention.

We claim:

1. A method for simultaneous participation of remote users on-line, wherein said users are provided software for installation on a computer that communicates with a network domain having a plurality of servers and a Web site, comprising the acts of:
providing a forum, wherein the forum is based on a theme;
enabling said users to each create at least one unique character for participation in the forum; and
enabling real-time interaction between said users participating in the forum with their respective characters, wherein the interaction comprises selective communication between said users.

2. The method according to claim 1, wherein the theme is a sports game and the forum is a venue particular to the sports game.

3. The method according to claim 2, wherein the sports game is a baseball game and wherein the forum is selected from the group consisting of a baseball stadium, a training facility, a batting cage and a track.

4. The method according to claim 3, wherein the character is a baseball player and wherein the character is created with optional and assigned characteristics.

5. The method according to claim 4, wherein the optional characteristics comprise the character's appearance, playing position and uniform.

6. The method according to claim 5, wherein the user creates the character's appearance, in part, by transmitting digital pictures to the Web site.

7. The method according to claim 4, wherein the assigned characteristics comprise an initial DNA value that is randomly assigned to each created character, wherein the initial DNA value is a total value for a plurality of characteristics, each said characteristic being assigned a characteristic value comprising a portion of the initial DNA value, and wherein the initial DNA value is substantially equal for each said created character.

8. The method according to claim 7, wherein the characteristic value is alterable following the creation of the character.

9. The method according to claim 8, wherein the characteristic value is positively altered upon participation of the character in the forum.

10. The method according to claim 8, wherein the characteristic value is negatively altered upon non-participation of the character in the forum.

11. The method according to claim 3, further comprising the act of enabling a plurality of users to register a team comprising the user's created characters, wherein the team competes with other teams in the forum.

12. The method according to claim 11, wherein each team is assigned to a level based on a point system, wherein points are awarded to the team for positive outcomes resulting from participating in league games, and wherein upon amassing a predetermined number of points, the team will be assigned to a higher level.

13. The method according to claim 12, wherein each team is initially assigned to an amateur level.

14. The method according to claim 12, further comprising the act of enabling a plurality of teams to compete in a league, having a schedule of league games, wherein each league is formed of teams assigned to a similar level.

15. The method according to claim 14, further comprising the act of conducting a league tournament in the forum upon completion of said league games, wherein a league champion is determined upon completion of the league tournament.

16. The method according to claim 15, further comprising the act of conducting a world tournament in the forum between league champions, wherein a world champion is determined upon completion of the world tournament.

17. The method according to claim 3, wherein the selective communication further comprises speaking to a particular user in the forum using voice over IP.

18. The method according to claim 3, wherein the selective communication further comprises speaking to a particular user in the forum using text messaging.

19. The method according to claim 1, wherein the forum is created by assimilating a plurality of digital pictures taken of a venue particular to the theme.

20. The method according to claim 1, wherein the step of enabling the user to create a unique character comprises assimilating a plurality of digital pictures taken of the user.

21. The method according to claim 1, wherein the selective communication further comprises speaking to a particular user in the forum using voice over IP.

22. The method according to claim 1, wherein the selective communication further comprises speaking to a particular user in the forum using text messaging.

23. The method according to claim 1, further comprising the act of providing each character with a unique viewpoint, wherein the viewpoint is consistent with the position of the character in the forum.

24. The method according to claim 1, wherein the theme is education and wherein the forum is a classroom.

25. The method according to claim 1, wherein the theme is shopping and wherein the forum is a store or showroom.

26. The method according to claim 1, wherein the theme is professional services and wherein the forum is an office.

27. A method for simultaneous participation of remote users in an online baseball game, wherein said users are provided software for installation on a computer that communicates with a network domain having a plurality of servers and a Web site, comprising the acts of:
enabling said users to each create at least one unique character for participation in the baseball game, wherein the character is created with optional and assigned characteristics;
providing a baseball related forum, wherein said users participate in the forum with their respective characters; and
enabling real-time interaction between said users, wherein the interaction comprises selective communication between said users.

28. The method according to claim 27, wherein the optional characteristics comprise the character's appearance, playing position and uniform.

29. The method according to claim 28, wherein the user creates the character's appearance, in part, by transmitting digital pictures to the Web site.

30. The method according to claim 27, wherein the assigned characteristics comprise an initial DNA value that is randomly assigned to each created character, wherein the initial DNA value is a total value for a plurality of characteristics, each said characteristic being assigned a characteristic value comprising a portion of the initial DNA value, and wherein the initial DNA value is substantially equal for each said created character.

31. The method according to claim 30, wherein the characteristic value is alterable following the creation of the character.

32. The method according to claim 31, wherein the characteristic value is positively altered upon participation of the character in the forum.

33. The method according to claim 31, wherein the characteristic value is negatively altered upon non-participation of the character in the forum.

34. The method according to claim 27, further comprising the act of enabling a plurality of users to register a team comprising the user's created characters, wherein the team competes with other teams in the forum.

35. The method according to claim 34, wherein each team is assigned to a level based on a point system, wherein points are awarded to the team for positive outcomes resulting from participating in league games, and wherein upon amassing a predetermined number of points, the team will be assigned to a higher level.

36. The method according to claim 35, wherein each team is initially assigned to an amateur level.

37. The method according to claim 35, further comprising the act of enabling a plurality of teams to compete in a league, having a schedule of league games, wherein each league is formed of teams assigned to a similar level.

38. The method according to claim 37, further comprising the act of conducting a league tournament in the forum upon completion of said league games, wherein a league champion is determined upon completion of the league tournament.

39. The method according to claim 38, further comprising the act of conducting a world tournament in the forum between league champions, wherein a world champion is determined upon completion of the world tournament.

40. The method according to claim 27, wherein the selective communication further comprises speaking to a particular user in the forum using voice over IP.

41. The method according to claim 27, wherein the selective communication further comprises speaking to a particular user in the forum using text messaging.

42. A method for simultaneous participation of remote users in an organized forum, comprising the acts of:
providing a forum, wherein the forum is based on a theme;
enabling said users to each create at least one unique character for participation in the forum; and
enabling real-time interaction between said users participating in the forum with their respective characters.
